(19) United States
(12) Patent Application Publication
(10) Pub. No.: US 2023/0163316 A1
(43) Pub. Date: May 25, 2023

(54) CARRIER-FREE OXYGEN REDUCTION CATALYST FOR USE IN LOW-TEMPERATURE FUEL CELLS AND METHOD FOR PRODUCING SAME

(71) Applicant: TECHNISCHE UNIVERSITÄT DARMSTADT, Darmstadt (DE)

(72) Inventors: Ulrike KRAMM, Darmstadt (DE); Markus KÜBLER, Stuttgart (DE); Vladislav GRIDIN, Langen (DE)

(21) Appl. No.: 17/921,454

(22) PCT Filed: Apr. 27, 2021
(86) PCT No.: PCT/EP2021/060952

§ 371 Date: Oct. 26, 2022

(30) Foreign Application Priority Data
Apr. 29, 2020 (DE) 10 2020 111 647.0

(51) Int. Cl. H01M 4/90; C08F 134/00

(52) U.S. Cl. CPC H01M 4/9008; H01M 4/9091; C08F 134/00; C08F 2810/00

(57) ABSTRACT

An oxygen reduction catalyst for use in low-temperature fuel cells and a method for the production thereof. This is in particular carrier-free and free from precious metals. It is based on a conductive polymer produced from a nitrogenous aromatic monomer, which leads to conductive polymers, and an aromatic sulfonic acid, which polymer is pyrolyzed together with one or more transition metal salts and is subsequently acid etched. In one particularly advantageous configuration variant, this involves a polypyrrole produced with sulfanilic acid as a doping agent.

### FIELD OF THE INVENTION

The present invention relates to an oxygen reduction catalyst for use in low-temperature fuel cells and a method for the production thereof. This does not require in particular a carrier and is free from precious metals.

### BACKGROUND OF THE INVENTION

In terms of the use of renewable energies and alternative drives, electrochemical reactions offer the possibility of quick and environmentally friendly conversion of chemical energy into electrical energy. Fuel cells are used, for example, for this purpose. The cathode in polymer electrolyte membrane fuel cells currently contains Pt/C catalysts as the catalyst which is required for the process. These do indeed have very high catalytic activity, but are extremely expensive due to the platinum and exhibit poor stability and susceptibility to catalyst poisoning, hence the durability and the price of these catalysts have hitherto been an obstacle to the extensive use of this technology.

Metal-nitrogen-carbon (M-N-C) materials are being intensively studied as highly promising, low-cost alternatives to Pt/C catalysts. In this case, there are still various problems in the configuration of the carbon structure and morphology, in particular in terms of porosity. A typical problem is furthermore the density at active centers. Since the active centers are formed during high-temperature pyrolysis, the catalysts typically contain, in addition to the active centers, also undesirable, inorganic metal species as contaminants. This is in particular the case for synthesis with a high metal proportion and at high pyrolysis temperatures. High metal proportions would, however, be advantageous in order to form more active centers overall.

A further problem relates to the carbon which is required for the electron transport and gas transport. During the synthesis of the M-N-C catalysts, the carbonization reaction is bound to the formation of the active centers. In the case of a low pyrolysis temperature, more active centers are typically retained (and thus fewer contaminants), but the carbon tends to be amorphous and is thus less stable during actual fuel cell use. In the case of a higher pyrolysis temperature, greater graphitization of the carbon is achieved (i.e. improved stability in the fuel cell), but at the same time the density of the active centers is reduced and more secondary products are formed.

In order to keep the proportions of inorganic metal species as low as possible, the metal proportion and the pyrolysis temperature must accordingly be kept low. In order to obviate this drawback with the objective of obtaining as pure as possible catalysts with as high as possible a center density alongside simultaneously good graphitization, Dong Liu, Jin-Cheng Li, Qiurong Shi, Shuo Feng, Zhaoyuan Lyu, Shichao Ding, Leiduan Hao, Qiang Zhang, Chenhui Wang, Mingjie Xu, Tao Li, Erik Sarnello, Dan Du und Yuehe Lin in the article “Atomically Isolated Iron Atom Anchored on Carbon Nanotubes for Oxygen Reduction Reaction” in ACS Applied Materials & Interfaces, 2019, 11 (43), page 39820-39826, DOI: 10.1021/acsami.9b12054 proposed a synthesis which supplies an ironbased Fe—N—C catalyst with a carbon nanotube structure.

In this case, individual iron atoms are fixed on the wall of carbon nanotubes. The synthesis uses an intermediate product composed of methyl orange and FeCl₃ for this purpose. Pyrrole is then added in drops into this solution and a polypyrrole nanotube structure is generated with stirring. This polypyrrole was subsequently subjected to pyrolysis in an initial nitrogen atmosphere, which was changed after 30 minutes into an NH₃ atmosphere and then cleaned by acid etching with sulfuric acid. A comparative test consisted of the identical production of a catalyst, but without the addition of methyl orange. It is demonstrated in this case that the methyl orange is responsible for the formation of the hollow nanotubes in the polypyrrole.

It is in particular underlined in the article and proved with the comparative experiment with irregularly agglomerated carbon that the nanotube structure is vital for improved oxygen reduction performance. The three key aspects for improved performance are high crystallinity of the carbon nanotube network, the configuration with a large number of nitrogen defects which are coordinated with individual iron atoms and with further nitrogen atoms, and a high specific surface with a large number of micropores in the wall. It is nevertheless conceded that performance in an acid milieu still requires improvement.

The disadvantages of this catalyst and its synthesis include in particular the toxicity of the methyl orange as well as the poor processability of the catalyst material to form a functioning electrode. The latter is caused by the nanotube structure of the catalyst material and the associated high crystallinity. The activity, which is still in need of improvement, of the catalyst for the oxygen reduction reaction should also be mentioned.

### SUMMARY OF THE INVENTION

Proceeding from these problems, one object of the present invention was to provide a carrier-free oxygen reduction catalyst and a production method for this, with which the disadvantages of the catalysts and method from the prior art are overcome. In particular, it was the object of this invention to provide a method which leads in a simple manner to a highly active catalyst which is stable over a long period of time and can in particular be easily further processed.

### BRIEF DESCRIPTION OF THE DRAWINGS

FIG. 1 shows polarization curves of proton exchange membrane fuel cells using the precious metal-free cathode catalyst according to the invention in H₂ air. Graph (a) plots the cell voltage against the current density, while graph (b) plots the power density against the current density. Catalysts synthesized with different doping agents are compared.

FIG. 2 shows proton exchange membrane fuel cells in 20 h stability tests using the precious metal-free cathode catalyst in H₂ air. Graph (a) plots the current density against time in the case of a potential of 0.5 V, while graph (b) plots the current density in % against time. Catalysts synthesized with different doping agents are compared.

FIG. 3 shows transmission electron microscopy (TEM) photographs of a catalyst produced with (a) polypyrrole-methyl orange, a catalyst produced (b) in an identical manner but with polypyrrole-sulfanilic acid and a catalyst produced (c) in an identical manner but with polypyrrole-toluenesulfonic acid. The difference in the morphology of the obtained carbon becomes clear.

FIG. 4 shows the BET surface determined from N₂ sorption measurements of polypyrrole-methyl orange-based catalysts which were produced using polypyrrole precursors washed with different frequencies.

FIG. 5 shows polarization curves of proton exchange membrane fuel cells using the precious metal-free cathode catalyst according to the invention in H₂—O₂. Catalysts which were produced using polypyrrole precursors washed with different frequencies are compared.

FIG. 6 shows rotating ring disk electrode (RRDE) measurements of polypyrrole-methyl orange-based catalysts which were produced using various iron salt precursors. Graph (a) shows activity measurements and (b) hydrogen peroxide development.

FIG. 7 shows polarization curves of proton exchange membrane fuel cells using two precious metal-free cathode catalysts in H₂—O₂. Catalysts which were produced with different quantities of FeCl₃ and Fe(NO₃)₃×9H₂O are compared. Graph (a) plots the potential against the current density, while graph (b) plots the power density against the current density.

FIG. 8 shows rotating ring disk electrode (RRDE) measurements on polypyrrole-methyl orange-based catalysts, graph (a) shows activity measurements and graph (b) shows the hydrogen peroxide development. Catalysts which were produced starting from a metal source or two different metal sources are compared.

FIG. 9 shows polarization curves of proton exchange membrane fuel cells using precious metal-free cathode catalysts in H₂—O₂. Catalysts synthesized with FeCl₃ and a mixture of FeCl₃ and a manganese salt (KMnO₄ or Mn(Ac)₂) are compared. Graph (a) plots the potential against the current density, while graph (b) plots the power density against the current density.

FIG. 10 shows short-term stability tests of proton exchange membrane fuel cells using the precious metal-free cathode catalyst in H₂—O₂. This is a potentiostatic measurement in the case of 0.6 V. Catalysts synthesized with FeCl₃ and with the addition of a manganese salt (KMnO₄ or Mn(Ac)₂) are compared. Graph (a) plots the current density against time, graph (b) plots the current density in % against time.

FIG. 11 shows polarization curves of proton exchange membrane fuel cells using precious metal-free cathode catalysts in H₂—O₂. Graph (a) plots the current density against the cell voltage, while graph (b) plots the current density against the power density. Catalysts synthesized with different proportions and quantities of FeCl₃ and KMnO₄ are compared.

FIG. 12 shows short-term stability tests of proton exchange membrane fuel cells using the precious metal-free cathode catalyst in H₂—O₂. Catalysts synthesized at 800° C., 900° C. and 1000° C. are compared. The current density in % is plotted against time.

FIG. 13 shows the ⁵⁷Fe-Mössbauer spectra of two catalysts which were etched exclusively in mineral acid or with the additional of isopropanol. The influence of the isopropanol addition on the structural composition is compared.

FIG. 14 shows polarization curves of proton exchange membrane fuel cells using the precious metal-free cathode catalyst in H₂ air. Graph (a) plots the current density against the cell voltage, while graph (b) plots the current density against the power density. Catalysts which were etched with or without the presence of isopropanol during the etching step are compared.

FIG. 15 shows polarization curves of proton exchange membrane fuel cells using the pyrolyzed catalyst (PPy), the fluorinated catalyst (PPy_fluorination) and the subsequently heat-treated, fluorinated catalyst (PPy_heat treatment) from Example 3 in H₂ air at 81° C. Graph (A) plots the cell voltage against the current density and graph (B) plots the power density against the current density.

FIG. 16 shows the stability tests of the catalysts from FIG. 15 which were performed in the proton exchange membrane fuel cell for 90 h in H₂ air at 81° C. and a potential of 0.5 V. Graph (A) plots the current density against time and graph (B) represents the relative current density against time. The effect of fluorination and subsequent heat treatment on stability is compared.

### DETAILED DESCRIPTION OF THE INVENTION

This object is achieved by a method and an oxygen reduction catalyst as claimed in the independent claims. Preferred configuration variants are the subject matter of the dependent claims.

The method according to the invention for producing a carrier-free oxygen reduction catalyst for use in low-temperature fuel cells contains in the indicated sequence the steps

a) producing a solution of a nitrogenous aromatic monomer, which leads to conductive polymers, and an aromatic sulfonic acid,
b) producing a solution of an oxidizing agent,
c) mixing the solutions from step a) and b) and allowing the mixture to stand to produce a doped conductive polymer, which is isolated, for example, by filtration or evaporation of the water, wherein the solutions from step a) and b) can optionally be mixed with one or more transition metal salts in order to directly obtain a precursor mixture,
d) in so far as the precursor mixture was not already produced in step c), producing the precursor mixture by 1.) mixing the doped conductive polymer with one or more transition metal salts or 2.) impregnating the doped conductive polymer with a dispersion of one or more transition metal salts,
e) pyrolysis of the precursor mixture in an inert gas atmosphere for producing the catalyst,
f) performing an acid etching step with a mixture of a mineral acid and a solvent for producing an etched catalyst,
g) pyrolysis of the etched catalyst in an inert gas atmosphere or a reactive gas atmosphere,
h) optionally repeating steps f) and g).

The solutions in step a) and b) are preferably produced with water. In so far as the water solubility is not sufficient, mixtures of water and organic solvents or organic solvents can also be used.

The doped conductive polymers can be obtained in step c), for example, by filtration or evaporation of the solvent.

Impregnation in step d) 2.) is performed, for example, with a dispersion in a mixture of water and an alcohol and subsequent drying.

The term “carrier-free” should be understood in the context of the application in particular such that the catalyst is not applied on a carrier material either during production or during use. In particular, no carbon-based carrier materials are used, such as, for example, carbon nanotubes, graphene, graphite, carbon fibers, carbon aerogel or carbon black. Only the conductive polymer is required as a carbon source for the catalyst according to the invention with an M-N-C structure. As a result of this, it is possible to achieve a higher density of active centers in comparison with carbon-supported M-N-C catalysts.

The term mineral acid in the context of the application refers to the narrow definition as a collective term for HCl, H₂SO₄ and HNO₃.

The nitrogenous aromatic monomer which leads to conductive polymers is preferably selected from pyrrole, aniline, carbazole and indole, with it most preferably being pyrrole.

The aromatic sulfonic acid is preferably selected from sulfanilic acid, benzenesulfonic acid, toluenesulfonic acid, dodecylbenzenesulfonic acid and naphthalenesulfonic acid, with it most preferably being sulfanilic acid.

The core element of the invention is that the conductive polymer was polymerized in the presence of a doping agent, namely an aromatic sulfonic acid. The combination of pyrrole polymer of the sulfanilic acid is particularly preferred. The reaction mixture for pyrolysis is accordingly composed of a doped conductive polymer and one or more transition metal salts. Due to the fact that the catalyst according to the invention is not applied on a carrier or has a highly crystalline nanotube structure, it is significantly easier to process to form a functioning electrode. It is furthermore easier to produce since no carrier material is required which has to be produced separately. The aromatic sulfonic acids used as a doping agent, in particular the sulfanilic acid, are, in contrast to azo dyes such as methyl orange, not toxic.

It has surprisingly been shown that improved activity and structure of the catalysts is not dependent on a nanotube structure. In contrast, even more improved activity is achieved if the conductive polymer is not polymerized in the presence of methyl orange, but rather in the presence of aromatic sulfonic acids. This effect is particularly pronounced in the case of the combination polypyrrole/sulfanilic acid. In contrast to methyl orange, no nanotubes are formed, but rather an amorphous structure. If the polymer is synthesized in the presence of a doping agent with a sulfonic acid group and a phenyl residue, activity and structure of the catalyst are significantly improved. Despite a lower loading, a catalyst reaches, for example, starting from polypyrrole produced with sulfanilic acid a higher current density than a catalyst which was synthesized starting from polypyrrole produced with methyl orange. This was thus not to be expected since Liu et al., as described above, had regarded it as a key prerequisite for improved catalyst performance that this has a nanotube structure onto which the individual iron atoms are applied.

The method according to the invention furthermore reduces the formation of inorganic metal species and thus allows higher metal proportions in terms of the active species as well as higher pyrolysis temperatures. A significant increase in activity and stability of the catalyst, in particular with sulfanilic acid, was furthermore achieved in comparison with the prior art.

In step a) the molar ratio of nitrogenous aromatic monomer to aromatic sulfonic acid is preferably from 30:1 to 1:1, particularly preferably from 30:1 to 5:1, more preferably from 25:1 to 10:1, most preferably from 25:1 to 15:1. Extremely high contents of aromatic sulfonic acid have a disadvantageous effect on the polymerization reaction. Insufficient doping and structural influencing result from an extremely low content of aromatic sulfonic acid.

The molar ratio of oxidizing agent in step b) to nitrogenous aromatic monomer in step a) is preferably from 1:5 to 5:1, particularly preferably from 1:4 to 4:1, more preferably from 1:3 to 3:1, most preferably from 1:1.5 to 1.5:1. Good results can be achieved in particular with a molar ratio of 1:1.

The oxidizing agent in step b) is preferably selected from H₂O₂, ammonium peroxodisulfate or a trivalent iron salt (such as FeCl₃). Of these, FeCl₃ is particularly preferred since it can serve as an additional metal source.

The allowing to stand in step c) for polymerization is preferably performed for 1 60 hours, particularly preferably 5-48 hours, more preferably 8-24 hours, most preferably 10-15 hours. The temperature here is preferably from −25° C. to 25° C., particularly preferably −20° C. to 10° C., more preferably −20° C. to 0° C., most preferably −15° C. to 0° C. In particular, polymerizations for 8-24 hours at a temperature of −20° C. to 0° C. have been shown to be advantageous.

The processing of the reaction mixture from step c) is performed by filtration or evaporation of the water. In this case, a washing of the polymer for cleaning is not absolutely necessary. This can also be dispensed with. It has been shown that a residual content of doping agent, in particular of sulfanilic acid, in the pyrolysis mixture has a positive effect on the activity of the catalyst. This is due among other things to an elevation of the BET surface.

The transition metal salts in step c) and d) are preferably selected from salts of Fe, Mn, Co, Ni, Cu, Cr, V, W, Mo, Zn and Ru. Particularly preferred transition metal salts are selected from FeCl₃, FeCl₂, Fe(NO₃)₃, KMnO₄, COCl₂ and Co(NO₃)₂. The combinations COCl₂/Co(NO₃)₂, FeCl₃/KMnO₄, FeCl₃/Mn(Ac)₂ and FeCl₃/Fe(NO₃)₃ are most preferred. A surprising synergistic effect occurs in each case in the case of the latter combinations of two transition metal salts. The catalysts produced with these salt combinations exhibit significantly improved activity and selectivity.

In step c) or d), the weight ratio of doped conductive polymer to transition metal salts is preferably from 1:0.1 to 1:10, particularly preferably from 1:1 to 1:7.5, more preferably from 1:1.25 to 1:5, most preferably from 1:1.5 to 1:3.

The production of the precursor mixture for the pyrolysis in step e) can be performed according to the invention in three different manners. The precursor mixture must contain the doped conductive polymer and one or more transition metal salts. For this purpose, the transition metal salt(s) can already be added during the polymerization of the nitrogenous aromatic monomer in step c). This is, however, only expedient if a washing of the doped conductive polymer is dispensed with since otherwise uncontrolled quantities of transition metal salts are washed out. The other two options for the production of the precursor mixture provide the addition of the transition metal salt(s) to the prepared doped conductive polymer in a separate step d).

In the dry method according to step d) 1.), a mixing of the doped conductive polymer with one or more transition metal salts is performed. This preferably involves a mechanical mixing. In particular deagglomerating mixers are suitable for this. The mixing in step d) 1.) is preferably performed in a ball mill. The ball mill achieves a deagglomeration and particle size equalization alongside good mixing through. For example, good results can be achieved at 30 Hz in 15 min with a mill from the company Retsch model NM400.

In the wet method according to step d) 2.), an impregnation of the doped conductive polymer with a dispersion of one or more transition metal salts is performed. This is performed, for example, in a mixture of water and an alcohol and subsequent drying. The alcohol can be selected from ethanol, methanol, isopropanol and polyols such as, for example, ethylene glycol, diethylene glycol, triethylene glycol, glycerol and propylene glycol. As an alternative to an alcohol, dimethylformamide and tetrahydrofuran are also suitable as solvents.

During pyrolysis in step e) and/or g), heating up is preferably performed with a heating rate from 100° C./h to 1000° C./h, particularly preferably 150° C./h to 750° C./h, more preferably 200° C./h to 500° C./h, most preferably 250° C./h to 350° C./h. In this case, heating up is preferably performed to a temperature from 600° C. to 1200° C., particularly preferably 700° C. to 1175° C., more preferably 800° C. to 1150° C., most preferably 900° C. to 1100° C. This temperature is then preferably maintained for 0.1 h to 10 h, particularly preferably 0.3 h to 6 h, more preferably 0.4 h to 4 h, most preferably 0.5 h to 2 h. Subsequently, cooling is preferably performed to 10° C. to 100° C., particularly preferably 15° C. to 70° C., more preferably 15° C. to 50° C., most preferably 20° C. to 30° C. Cooling is performed in an inert gas atmosphere.

In particular the acid etching step also contributes to a higher purity of the catalyst. In contrast to the prior art, according to the invention, not only an acid is used, but rather a mixture of a mineral acid and a solvent. The solvent can be an organic solvent. This makes it possible to disperse the carbon particles of the catalyst more finely and break up agglomerates. The etching step thus becomes significantly more effective than in the prior art. Significantly more undesirable iron phases, because they are non-catalytically active and inorganic, can be removed. Through the addition of the solvent, the capacity to remove inorganic iron secondary phases is significantly improved. At least 50 wt.-% of the non-catalytically active inorganic iron secondary phases is removed. Preferably at least 60 wt.-%, at least 65 wt.-%, at least 70 wt.-%, at least 75 wt.-%, at least 80 wt.-% of the non-catalytically active inorganic iron secondary phases is removed.

The acid etching step in step f) is preferably performed for 1 h to 10 h, particularly preferably 1.5 h to 8 h, more preferably 2 h to 5 h, most preferably 2.5 h to 3.5 h, in an ultrasound bath in an inert gas atmosphere. The temperature is preferably 20° C. to 100° C., particularly preferably 30° C. to 90° C., more preferably 40° C. to 80° C., most preferably 50° C. to 60° C. The inert gas used is preferably nitrogen or argon.

Moreover, the acid etching step in step f) is preferably performed with a 0.1 M to 10 M, particularly preferably 0.5 M to 8 M, more preferably 1 M to 6 M, most preferably 2 M to 5 M, mineral acid and an organic solvent selected from isopropanol, ethanol, methanol, polyols such as, for example, ethylene glycol, diethylene glycol, triethylene glycol, glycerol, propylene glycol, dimethylformamide, tetrahydrofuran and pyridine. Suitable solvents are in particular characterized in that they reduce the surface tension of the water. The volume ratio of mineral acid to solvent is in this case preferably 1:10 to 10:1, particularly preferably 1:7.5 to 7.5:1, more preferably 1:5 to 5:1, most preferably 1:2 to 2:1.

After the acid etching step in step f), the mixture is preferably allowed to rest for 10 h to 24 h, particularly preferably 10 h to 20 h, more preferably 10 h to 15 h, most preferably 11 h to 13 h, before it is filtered, washed and dried.

During pyrolysis in step g) the reactive gas is preferably selected from N₂/H₂, H₂, CO₂, NH₃.

A significant problem of the precious metal-free catalysts is the significantly lower stability in comparison with platinum-based materials. The reduction in stability can be brought about via several mechanisms. Demetallization, carbon corrosion, pore flooding and poisoning of the active centers are discussed as possible causes. It was surprisingly found that, as a result of the additional synthesis step of fluorination of the already pyrolyzed catalyst and subsequent renewed pyrolysis, the deactivation is further reduced and thus higher stability can be achieved. This result was completely unexpected since other effects were suspected proceeding from the prior art.

The catalyst obtained is therefore most preferably fluorinated and subsequently pyrolyzed again after the pyrolysis in step g) by conversion with a fluorinating agent.

It has been shown during fluorination with a fluorinating agent that particularly good results are achieved if the already pyrolyzed catalyst is modified by wet chemistry with a fluorination reagent via a diazonium salt. Here, a primary amino group at the fluorination reagent is converted in the presence of a nitrite compound to form the diazonium salt. It is correspondingly particularly preferred if the fluorinating agent comprises a fluoride compound with a primary amino group and a nitrite compound.

The fluoride compound with a primary amino group is preferably a perfluorinated aromatic compound, in particular pentafluoro-aniline, and/or the nitrite compound is an inorganic nitrite salt, in particular an alkali metal nitrite. The alkali metal nitrite can preferably be selected from lithium nitrite, sodium nitrite, potassium nitrite or rubidium nitrite, in particular sodium nitrite or potassium nitrite, particularly preferably sodium nitrite.

The precursor mixture is produced for fluorination with a fluorinating agent according to step d) 1.) preferably in a ball mill. The pyrolyzed catalyst thus obtained according to step g) is subsequently dispersed in a mixture of water and an alcohol. The alcohol is preferably selected from the short-chained n- or iso-alkanols with 1-5 carbon atoms, this involving in particular methanol, ethanol, isopropanol or n-butanol.

The volume ratio of water to alcohol can in this case be from 1:1 to 4:1, preferably from 1:1 to 3:1, in particular from 1:1 to 2:1.

In the mixture of water and alcohol, 1.0 mass equivalents of the pyrolyzed catalyst are dispersed and brought to a reaction temperature of 4° C. to 80° C. The reaction temperature can preferably be 10° C. to 70° C., 20° C. to 65° C., 30° C. to 60° C., 40° C. to 60° C. or 45° C. to 55° C.

0.1 to 4 mass equivalents of HBF₄ and 0.02 to 3 mass equivalents of the fluorinating reagent are added to the dispersion. The mass equivalents HBF₄ are preferably 0.12 to 3.5 or 0.14 to 3 or 0.16 to 2.5 or 0.18 to 2 or 0.2 to 2 or 0.2 to 1. The mass equivalents of the fluorinating reagent are preferably 0.04 to 2.5 or 0.06 to 2 or 0.08 to 1.5 or 0.10 to 1 or 0.2 to 2 or 0.10 to 0.75.

Moreover, a solution of 0.02 to 1 mass equivalents NaNO₂ in water at 25° C. is produced and added in drops to the dispersion. The mass equivalents of NaNO₂ are preferably 0.03 to 0.75 or 0.04 to 0.5 or 0.04 to 0.25.

The reaction mixture is subsequently maintained for a reaction time of 0.5 h to 2 h at the reaction temperature and subsequently filtered, washed and dried. The reaction time is preferably 0.6 h to 1.75 h or 0.7 h to 1.5 h or 0.8 h to 1.25 h.

After the end of fluorination, heat treatment is performed under inert gas and/or reactive gas. The reactive gas can preferably be nitrogen or a noble gas, in particular Ar. The reactive gas can preferably be N₂/H₂, NH₃ or CO₂.

The heating rate is 100° C./h to 1000° C./h, particularly preferably 300° C./h to 950° C./h or 500° C./h to 900° C./h or 700° C./h to 850° C./h or 750° C./h to 850° C./h. The heating up is performed up to a final pyrolysis temperature of preferably 250° C. to 1200° C., further preferably 400° C. to 1100° C. or 500° C. to 1000° C. or 600° C. to 950° C. or 700° C. to 900° C. The final pyrolysis temperature is preferably lower than 1000° C., further preferably lower than 950° C., further preferably lower than 900° C., particularly preferably lower than 875° C., most preferably lower than 850° C.

The pyrolysis is performed for a duration of 0.1 h to 10 h, preferably 0.15 h to 8 h or 0.2 h to 6 h or 0.2 h to 4 h or 0.2 h to 2 h.

The catalyst obtained in this manner is finally cooled under inert gas to 10° C. to 100° C., preferably 15° C. to 80° C. or 20° C. to 60° C. or 25° C. to 40° C.

Fluorination as such is already known in the literature both with elementary fluoride as well as with a fluorinating reagent. Proceeding from previous data relating to precious metal-free catalysts, the fluorination leads to a reduction in oxygen reduction activity which is presumably due to the electron-attracting property of the fluoride. Although the fluorination leads to a relative increase in stability (for example, 83% remaining activity after 100 h in comparison with 30% in the case of a non-fluorinated catalyst in the case of potential holding of 0.5V), the results of the prior art were, however, hitherto uninteresting in terms of technical application since the fluorinating step involves very large activity losses. For example, in the case of an initial activity of the untreated catalyst of 138 mA/cm², a reduction to 4.5 mA/cm² arises in the case of the fluorinated catalyst with a cell potential of 0.8V.

A regeneration of the oxygen reduction activity to the level of the initial catalyst along with a simultaneous increase in stability could thus surprisingly be brought about with the preferred combination of fluorination and downstream heat treatment. While the effect of subsequent heat treatment on activity was to be expected on the basis of the literature, the stability typically deceases with such treatment. Only the improvement in activity to be expected was thus observed in the prior art in the case of heat treatment of a previously fluorinated catalyst, but not to the previous extent, but rather only ˜25% of the initial activity. It is precisely the surprisingly found combination of a fluorination with a fluorinating agent and a subsequent, relatively low pyrolysis temperature which first achieves values which are interesting in terms of technical application.

According to the invention, a carrier-free oxygen reduction catalyst is furthermore produced as claimed in any one of the preceding methods.

The oxygen reduction catalyst most preferably does not have a carbon nanotube structure.

### EXAMPLES

### Example 1

An aqueous solution was produced from 3.5 g pyrrole and 0.436 g sulfanilic acid in 500 ml water. The molar ratio of pyrrole and sulfanilic acid was correspondingly 20.7:1. An aqueous solution of the oxidizing agent was furthermore produced from 8.1 g FeCl₃ in 500 ml water. The molar ratio of oxidizing agent to pyrrole was correspondingly 0.96:1.

Both solutions were mixed and allowed to stand for a reaction time of 600 min at a temperature of −10° C. The doped polypyrrole was obtained as a reaction product after filtration.

For the production of the precursor mixture for the pyrolysis, 1 g of the doped polypyrrole was mixed with 1.69 g FeCl₃ and 0.5 g KMnO₄ as transition metal salts. The weight ratio of doped polypyrrole to transition metal salts was correspondingly 1:2.19. Mixing was performed in 20 ml of a mixture of water and ethanol with the volume ratio 1:1. The dispersion of this mixture was performed for 20 min with an ultrasound bath. The solvent was evaporated at 75° C. under air in a drying chamber and the obtained precursor powder was crushed by hand.

The precursor mixture obtained in this manner was pyrolyzed in a high-temperature furnace under a nitrogen atmosphere. Heating up to a final pyrolysis temperature of 1000° C. was performed with a heating rate of 300° C./h. The retention period of the final pyrolysis temperature was 1 h. The pyrolysis product obtained was left to cool to 25° C. in the nitrogen atmosphere.

This was followed by an acid etching step with a mixture of 2 M HCl and isopropanol. The volume ratio of acid and solvent was 2:1. The acid etching step was performed at a temperature of 50° C. for 2.5 h in an ultrasound bath under a nitrogen atmosphere. The mixture was subsequently allowed to rest for 12 h, filtered, washed with 500 ml water and dried.

The etched catalyst was subsequently treated again in a second pyrolysis step under a nitrogen atmosphere. The heating rate was 800° C./h. The final pyrolysis temperature was 800° C. and was maintained for 15 min. It was allowed to cool to 25° C. under a nitrogen atmosphere.

### Model Example 1

The catalyst from model example 1 was produced in an identical manner to that from Example 1. However, in contrast to this, 0.819 g methyl orange was used instead of the 0.436 g sulfanilic acid during polymerization of the pyrrole.

### Example 2

The catalyst from Example 2 was produced in an identical manner to that from example 1. However, in contrast to this, 0.431 g p-toluenesulfonic acid was used instead of the 0.436 g sulfanilic acid during polymerization of the pyrrole.

### Model Example 2

The catalyst from model Example 2 was produced in an identical manner to that from model Example 1. During the production of the precursor mixture for the pyrolysis, however, in contrast to this, 1.0 g of the doped polypyrrole was mixed with 1.0 g FeCl₃ and 1.25 g Fe(NO₃)₃×9 H₂O. Moreover, the pyrolysis temperature of the first pyrolysis step was reduced to 800° C. The etching step was performed in 2 M HCl. No second pyrolysis was carried out.

### Model Example 3

The catalyst from model Example 3 was produced in an identical manner to that from model Example 2. After the production of the polypyrrole, this was, however, in contrast washed with 500 ml of a 1:1 (volume ratio) water-acetone mixture. This washing step was performed 5 times.

### Model Example 4

The catalyst from model Example 4 was produced in an identical manner to that from model Example 3. The washing step of the polypyrrole was in contrast performed 40 times.

### Model Example 5

The six catalysts from model Example 5 were produced in an identical manner to that from model Example 4. During the production of the precursor mixture for the pyrolysis, however, in contrast to this 1.0 g of the polypyrrole was mixed with the corresponding transition metal salts: These were 2.489 g Fe(NO₃)₃×9H₂O or 1.446 g FeCl₂×6 H₂O or 1.000 g FeCl₃ or 1.060 g Fe(Acetate)₂ or 1.106 g Fe(Oxalate)×2 H₂O or 0.666 g FeCl₃ with 0.834 g Fe(NO₃)₃×9 H₂O.

### Model Example 6

The two catalysts from model Example 6 were produced in an identical manner to that from model Example 5. In contrast to this, the polypyrrole was not washed after production. During the production of the precursor mixture for the pyrolysis, in contrast 1.0 g of the doped polypyrrole was mixed with the corresponding transition metal salts: These were 0.666 g FeCl₃ with 0.834 g Fe(NO₃)₃×9H₂O or 1.000 g FeCl₃ with 1.250 g Fe(NO₃)₃×9 H₂O. A second pyrolysis step was performed. The heating rate for this was 450° C./h. The final pyrolysis temperature was 800° C. and was maintained for 45 min. It was allowed to cool to 25° C. under a nitrogen atmosphere.

### Model Example 7

The five catalysts from model Example 7 were produced in an identical manner to that from model Example 5. During the production of the precursor mixture for the pyrolysis, however, in contrast 1.0 g of the doped polypyrrole was mixed with the corresponding transition metal salts. These were 1.000 g FeCl₃ or 0.974 g KMnO₄ or 1.062 g Mn(Acetate)₂ or 1.000 g FeCl₃ and 0.974 g KMnO₄ or 1.000 g FeCl₃ and 1.062 g Mn(Acetate)₂.

### Model Example 8

The three catalysts from model Example 8 were produced in an identical manner to that from model Example 7. During the production of the precursor mixture for the pyrolysis, 1.0 g of the doped polypyrrole was mixed with the corresponding transition metal salts. These were 1.000 g FeCl₃ or 1.000 g FeCl₃ and 0.974 g KMnO₄ or 1.000 g FeCl₃ and 1.062 g Mn(Acetate)₂.

### Model Example 9

The catalyst from model Example 9 was produced in an identical manner to that from model Example 8. In contrast, the polypyrrole was not washed after production. During the production of the precursor mixture for the pyrolysis, 1.0 g of the doped polypyrrole was mixed with 1.000 g FeCl₃ and 0.974 g KMnO₄. A second pyrolysis step was performed. The heating rate was 800° C./h. The final pyrolysis temperature was 800° C. and was maintained for 15 min. It was left to cool to 25° C. under a nitrogen atmosphere.

### Model Example 10

The catalyst from model Example 10 was produced in an identical manner to that from model Example 9. In contrast, during the production of the precursor mixture for the pyrolysis, 1.0 g of the doped polypyrrole was mixed with 1.690 g FeCl₃ and 0.500 g KMnO₄.

### Model Example 11

The three catalysts from model Example 11 were produced in an identical manner to that from model Example 10. In contrast, the final temperature of the first pyrolysis step was 800° C. or 900° C. or 1000° C.

### Model Example 12

The two catalysts from model Example 12 were produced in an identical manner to that from model Example 11. The final temperature of the first pyrolysis step was 1000° C. Two catalysts were produced, in the case of which the acid etching step was performed as described in Example 1 or as described in Example 1, but in contrast to this only in 2 M HCl and not in 2 M HCl and isopropanol.

### Example 3

The starting catalyst for Example 3 was produced in an identical manner to that from Example 1. In contrast, the precursors were mixed in a ball mill. Mixing was performed at 30 Hz for 15 min using four balls (ZrO₂, diameter 10 mm). The hereby produced pyrolyzed catalyst is referred to as PPy.

In a mixture of water and isopropanol with a volume ratio of 2:1, 1.0 mass equivalents of the pyrolyzed catalyst PPy were dispersed and heated to 50° C. The quantity ratio was 15 ml solution with 0.5 g pyrolyzed catalyst. For dispersion, 0.2 mass equivalents HBF₄ and 0.11 mass equivalents of the fluorinating reagent pentafluoro-aniline were added. Moreover, a solution of 0.04 mass equivalents NaNO₂ in water at 25° C. was produced and added in drops to the dispersion. The volume of the solution in this example was 300 μl with 20.7 mg NaNO₂. The reaction mixture was maintained at the reaction temperature of 50° C. for the duration of a reaction time of an hour and subsequently filtered, washed and dried. The fluorinated pyrolyzed catalyst obtained in this manner is referred to as PPy_fluorination.

The fluorinated pyrolyzed catalyst PPy_fluorination was subsequently subjected to heat treatment under N₂ as an inert gas. The heating rate was 800° C./h. The heating up was performed up to the final pyrolysis temperature of 800° C. which was maintained for 0.25 h. The heat-treated catalyst obtained in this manner was cooled to 25° C. under inert gas and referred to as PPy_heat treatment.

Influence of the Doping Agent

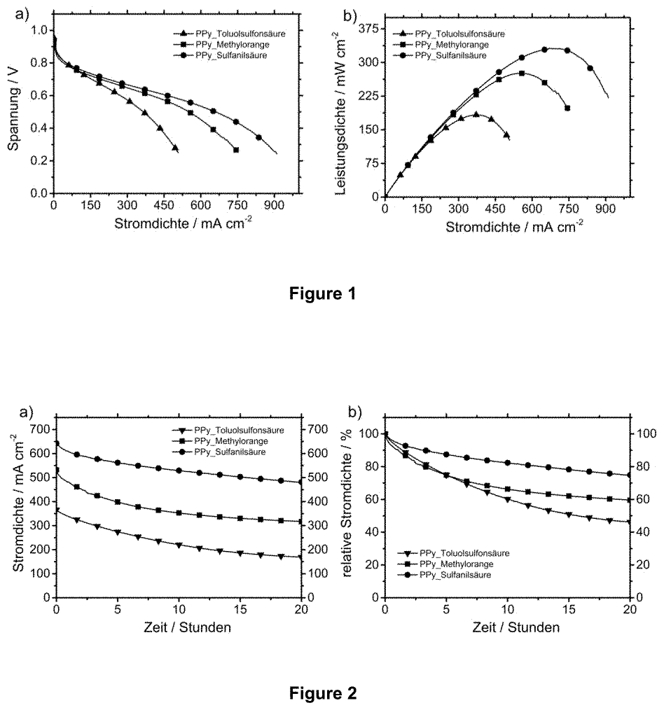

FIG. 1 shows the polarization curves of a proton exchange diaphragm fuel cell, prepared with catalysts proceeding from variously doped polypyrrole catalysts which were otherwise produced identically. Production is described in each case in Example 1, model Example 1 and Example 2. FIG. 2 shows the short-term stability tests of these catalysts. The difference in particular of the doping agent sulfanilic acid from the prior art becomes clear. FIG. 1 shows in this case a significant improvement in material transport properties, as is apparent in the increase in the current density in the case of low cell voltages (e.g. <0.6 V) of the catalyst doped with sulfanilic acid in comparison with the other two. In the prior art (methyl orange), the inferior material transport is above all due to the nanotube structure proceeding from the polypyrrole nanotubes. This is not formed during doping with sulfanilic acid.

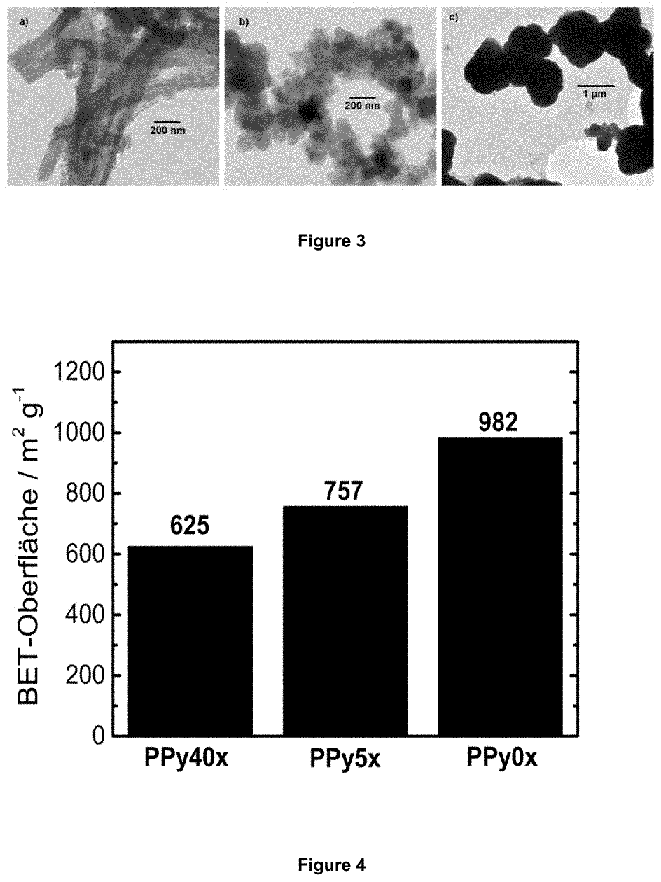

This is illustrated in FIG. 3. FIG. 3 a) shows the catalyst which was produced proceeding from polypyrrole-methyl orange. The nanotube structure is slightly changed by the pyrolysis and the acid etching step, but the fundamental structural element of the nanotube morphology is nevertheless also apparent in the finished catalyst. FIG. 3 b) shows the catalyst which was produced proceeding from polypyrrole-sulfanilic acid. A significantly finer morphology of the catalyst particles in comparison with FIG. 3 a) becomes clear, wherein it is not based on a nanotube structure. FIG. 3 c) furthermore shows the morphology of the catalyst produced proceeding from polypyrrole-toluenesulfonic acid. No nanotube structure is also present here, but the catalyst particles exhibit a rougher structure than in FIG. 3 b). The activity in the fuel cell, as shown in FIG. 1, is therefore lower for polypyrrole-toluenesulfonic acid-based catalysts than for those based on polypyrrole-methyl orange and significantly lower than for those proceeding from polypyrrole-sulfanilic acid. In addition to the improvement in the activity in the material transport-limited region of the polarization curve, FIG. 2 shows a significant improvement in the stability of the catalyst, which was produced starting from the polypyrrole doped with sulfanilic acid, in comparison with the prior art. The combination in particular of polypyrrole and sulfanilic acid thus has an unexpected effect on the morphology of the catalyst particles and on the activity and stability in the fuel cell.

The preparation of the membrane electrode assembly (MEA) was performed as follows for this purpose. Anode and cathode catalysts were initially processed in each case into inks. The composition of the anode inks consisted of 80 mg Pt/C Elyst Pt20 0390 from Umicore AG & Co. KG, 0.8 ml water, 0.8 ml of a 5% Nafion™ solution. The cathode ink was composed of 80 mg of the respective cathode catalyst, 0.26 ml water, 2 ml isopropanol and 1 ml of the 5% Nafion™ solution. The mixtures were dispersed in each case at T=10 to 15° C. in the ultrasound bath in order to obtain a homogeneous distribution. The catalyst inks were applied by means of airbrush pistol onto a gas diffusion layer SE H₂₃C9 from Freudenberg. The loading of the anodes was in each case 0.1 mg_{Pt} cm⁻². The loading of the cathode was 3.32 mg cm⁻² for the polypyrrole-sulfanilic acid-based catalyst, 3.49 mg cm⁻² for the polypyrrole-methyl orange-based catalyst and 3.72 mg cm⁻² for the polypyrrole toluenesulfonic acid-based catalyst. The slightly different loadings of the cathode catalysts arise as a result of the application of materials by the manual process with the airbrush pistol. As described by D. Banham, T. Kishimoto, Y. Zhou, T. Sato, K. Bai, J.-I. Ozaki, Y. Imashiro and S. Ye in the article “Critical advancements in achieving high power and stable nonprecious metal catalyst-based MEAs for real-world proton exchange membrane fuel cell applications” in Science Advances, 2018, 4, 3, DOI: 10.1126/sciadv.aar7180, it is known that a higher loading of the catalysts is associated with slightly improved activity and slightly improved stability. The MEA was achieved via hot pressing from the anode side, Nafion212 membrane and cathode side, wherein the surfaces coated with the catalyst were aligned in each case towards the Nafion membrane. The surface area of the MEA was 4.84 cm².

The measurement of the polarization curves was performed by means of the fuel cell test bench model 850e from Scribner Associates. The measurement was performed at a cell temperature of 81° C., with 96% humidification of the gases, 1 bar counterpressure and a gas flow of in each case 200 ml min⁻¹. The measurement was performed under H₂ air. The polarization curve was obtained by the gradual increase of the current starting from 0 A with a rate of 0.03 A every 10 seconds.

The measurement of the short-term stability tests was performed directly after the measurement of the polarization curve. For this purpose, a constant potential of 500 mV was applied and the current response was recorded for 20 hours.

The TEM photographs were taken with a FEl-Philips CM20. The acceleration voltage was 120 kV and a LaB₆ electrode was used. The samples were prepared by dispersion in isopropanol and dropping onto a TEM copper network with carbon hole film S147-4 from Plano™.

Influence of the Removal/Washing Out of the Doping Agent

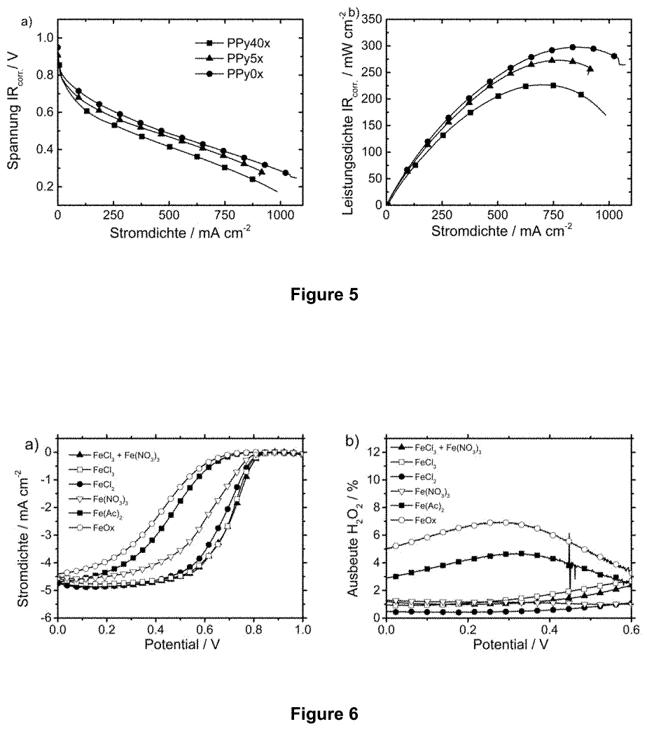

In order to study the influence by way of the removal of the doping agent or its content in the polypyrrole precursor, the polypyrrole-methyl orange-based catalyst system was used as a model compound which is analogous to the prior art and iron was selected as the metal. The synthesis of the catalysts is described in model Examples 2 to 4. Different quantities of doping agent in the precursor mixture was obtained by washing out the doping agent after the synthesis of the polypyrrole nanotubes. A catalyst was produced proceeding from unwashed precursor as described in model Example 2. A catalyst was produced proceeding from washed precursor as described in model Example 3, for this purpose a defined washing step was performed 5 times. Moreover, a catalyst was produced proceeding from washed precursor as described in model Example 4, for this purpose a defined washing step was performed 40 times. FIG. 4 shows the influence of the washing out of the doping agent after synthesis of the polypyrrole on the BET surface of the produced catalysts. FIG. 5 shows the polarization curves of a proton exchange membrane fuel cell in H₂—O₂, prepared with the described catalysts proceeding from variously washed polypyrrole precursors.

It is apparent from FIG. 4 that leaving the doping agent in the precursor can be positively noticed by an elevation of the BET surface. This effect is confirmed by increased activity in the fuel cell, as shown in FIG. 5. Since in the prior art the increase in the fuel cell activity is traced back to the formation of a nanotube structure, but this already arises during polymerization and is not changed by the washing step, the found effect of the doping agent on the BET surface is surprisingly novel over the prior art.

The measurements of the BET surfaces were performed by means of N₂ adsorption and desorption experiments. Approx. 40 mg of the catalysts were weighed out for this purpose. The experiments were performed with an Autosorb-3B from Quantachrome. The analysis software was also used correspondingly from Quantachrome. The degassing of the samples prior to measurement was performed under vacuum at 200° C. for 18 hours.

The preparation of the MEAs was performed in the same manner as that described in the section “Influence of the doping agent”. The loading of the cathode was 2.16 mg cm⁻² for the catalyst based on the unwashed polypyrrole precursor, 2.57 mg cm⁻² for the catalyst based on the polypyrrole precursor which is washed 5 times and 2.49 mg cm⁻² for the catalyst based on the polypyrrole precursor which is washed 40 times.

The measurement of the polarization curves was performed in the same manner as already described in the section “Influence of the doping agent”, but using the gases H₂—O₂.

Influence of the Transition Metal Precursor Used

In order to study the influence of the transition metal precursor, the polypyrrole-methyl orange-based catalyst system was used as a model compound which is analogous to the prior art and iron was selected as the metal. The synthesis is described in model Example 5. FIG. 6 shows the oxygen reduction activities of the catalysts using different iron salt precursors. The rotating ring disk electrode (RRDE) measurements show an increase in catalyst activity and selectivity using the salts FeCl₃, FeCl₂, as well as a mixture of FeCl₃ and Fe(NO₃)₃ in comparison with Fe(Ac)₂, FeOx (iron oxalate) and Fe(NO₃)₃.

The rotating ring disk electrode (RRDE) measurements were performed with the aid of an MSR rotator (Pine Instruments), an OD PEEK shaft and a “glassy carbon” carbon disk platinum ring electrode. A “glassy carbon” rod served as a counter electrode and an Ag/AgCl (3M KCl) electrode served as a reference electrode. All of the indicated potentials relate to the potential of the reversible hydrogen electrode. The potential of the reference electrode used was determined before the start of the measurement by means of a corresponding electrode Hydroflex® from Gaskatel GmbH. The Potentiostat Parstat3000A from AMETEK and the software Versa Studio from Princeton Applied Research were used. In order to produce the catalyst ink, 5 mg of the respective catalyst was dispersed for 45 min with 0.142 ml water, 0.083 ml isopropanol and 0.025 ml 5% Nafion™ in an Emmi®-H210 ultrasound bath. The catalyst loading of the working electrode was 0.5 mg cm⁻². All of the measurements were performed in 0.1 M H₂SO₄. The oxygen reduction curves shown are capacity-corrected, i.e. measurements at the same feed speed, but in nitrogen-saturated electrolyte, were subtracted from the actual measurement values. The measurements were recorded with a feed speed of 10 mV s⁻¹ and at a rotation of 1500 rpm. The cathodic sweeps of the measurement are represented. In order to determine the hydrogen peroxide yield, the platinum ring was initially activated in nitrogen-saturated solution by cycling. In parallel to the CVs at the disk in 02-saturated electrolyte (10 mV s⁻¹, 1500 rpm), a constant potential of 1.2 V was applied to the platinum ring of the rotating ring disk electrode and the current was recorded during the entire measurement. A value pair of I_{d} and Iᵣ can be assigned to each potential from the time dependency of both measurements (i.e. I_{d} (current at the working electrode with the catalyst) and Iᵣ (current at the ring electrode resulting from the oxidation of H₂O₂). Since not every hydrogen peroxide molecule on the ring electrode can be oxidized, the collection efficiency N describes the probability that it comes to pass. N is around 0.38 for the electrode geometry used. The following equation was used to calculate the hydrogen peroxide yield:

$$\% {H}_{2} {O}_{2} = \frac{2 {I}_{r} / N}{{I}_{d} + {I}_{r} / N}$$

Influence of the quantity of transition metal salts in a precursor mixture using the example of iron.

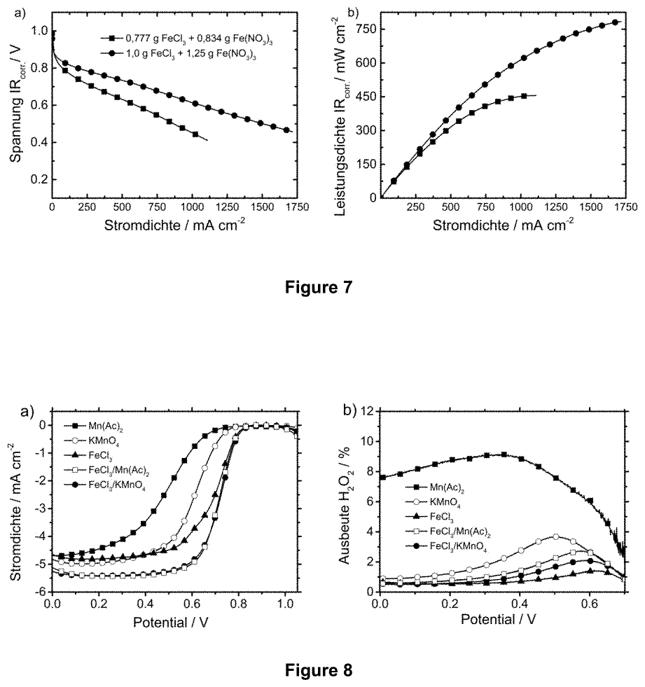

In order to study the effect of the added quantity of transition metal salts in the precursor mixture, catalysts as described in model Example 6 were produced. FIG. 7 shows the polarization curves of a proton exchange membrane fuel cell in H₂—O₂, prepared with catalysts proceeding from various proportions of FeCl₃ and Fe(NO₃)₃×9 H₂O which were otherwise produced in an identical manner. It is apparent from FIG. 7 that a catalyst, produced from a mixture of 1.0 g of the doped polypyrrole with 1.000 g FeCl₃ and 1.250 g Fe(NO₃)₃×9 H₂O, generates improved activity in the fuel cell than that produced from the mixture of 1.00 g of the doped polypyrrole as well as 0.666 g FeCl₃ and 0.834 g Fe(NO₃)₃×9 H₂O.

The preparation of the MEAs was performed in the same manner as described in the section “Influence of the doping agent”. The loading of the cathode was 3.3 mg cm⁻² for the catalyst based on the precursor mixture containing 1.000 g polypyrrole, 1.000 g FeCl₃ and 1.250 g Fe(NO₃)₃×9H₂O and 3.4 mg cm⁻² for the catalyst based on the precursor mixture containing 1.000 g polypyrrole, 0.666 g FeCl₃ and 0.834 g Fe(NO₃)₃×9 H₂O.

The measurement of the polarization curves was performed in the same manner as already described in the section “Influence of the doping agent”, but using the gases H₂—O₂.

Action of Manganese Salts as Additional Metal Source

In order to study the effect of KMnO₄ and Mn(Ac)₂ as additional second metal sources, catalysts as described in model Example 7 were produced. In turn, the polypyrrole-methyl orange-based catalyst system was used as a model compound which is analogous to the prior art. FIG. 8 shows the oxygen reduction activity as well as H₂O₂ production of the catalysts in the RRDE. The synergistic effect using Fe and Mn salts becomes clear on the basis of the reduced hydrogen peroxide quantity and the improved activity.

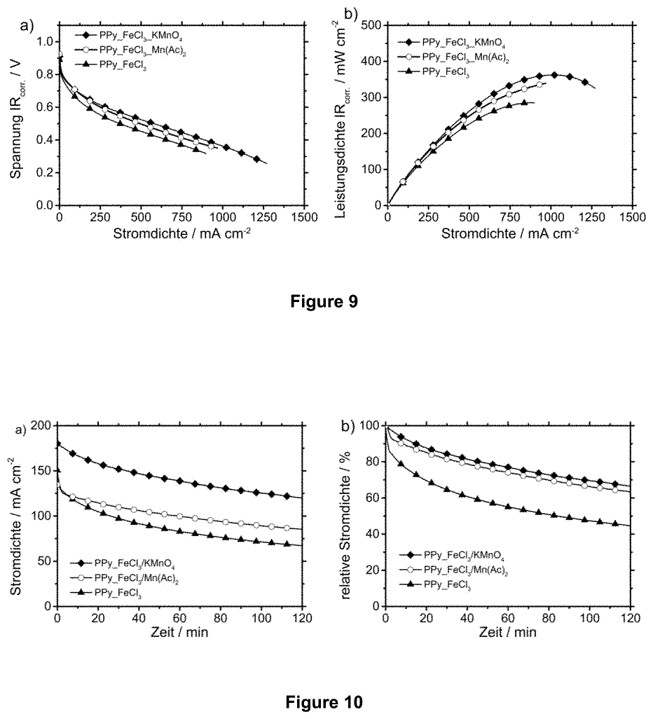

Improved activity and also stability of the catalysts in the fuel cell are likewise achieved. The activity can be read from the polarization curves in FIG. 9, which activity is in each case higher for both catalysts prepared with the addition of manganese than in the case of the pure iron catalyst. The improved stability becomes clear from FIG. 10 b) in the higher remaining relative current density after in each case the same measurement period. It is also apparent that KMnO₄ as a second precursor salt achieves better results than Mn(Ac)₂.

The rotating ring disk electrode (RRDE) measurements were performed in the same manner as already described in the section “Influence of the transition metal precursor used”.

The preparation of the MEAs is performed in the same manner as described in the section “Influence of the doping agent”. The loading of the cathode was 2.8 mg cm⁻² for the FeCl₃-based catalyst, 3.4 mg cm⁻² for the catalyst based on FeCl₃ and Mn(Ac)₂ and 2.7 mg cm⁻² for the catalyst produced with FeCl₃ and KMnO₄.

The measurement of the polarization curves was performed in the same manner as already described in the section “Influence of the doping agent”. But using the gases H₂—O₂.

The measurement of the short-term stability tests was performed in the same manner as already described in the section “Influence of the doping agent”, but using the gases H₂—O₂, a potential of 600 mV and a duration of 120 min.

Influence of the Quantity and the Ratio of the Transition Metal Salts to One Another in the Precursor Mixture

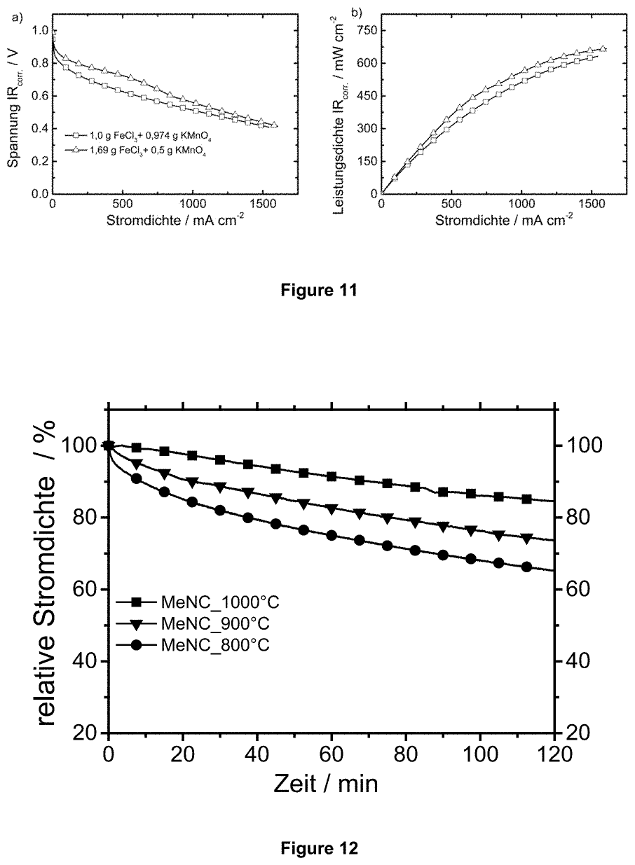

In order to study the effect of the added quantity and proportions of transition metal salts to one another, catalysts with FeCl₃ and KMnO₄ as described in model Example 9 and 10 were produced. FIG. 11 shows the polarization curves of a proton exchange membrane fuel cell, prepared with catalysts proceeding from various quantities and proportions of FeCl₃ and KMnO₄ which were otherwise produced in an identical manner. It is apparent from FIG. 11 that a catalyst, produced from a mixture of 1.000 g of the doped polypyrrole with 1.690 g (10.42 mmol) FeCl₃ and 0.500 g (3.16 mmol) KMnO₄ (total: 13.58 mmol transition metal, molar ratio FeCl₃ to KMnO₄ 3,3:1), generates improved activity in the fuel cell than that produced from the mixture of 1.000 g of the doped polypyrrole as well as 1.000 g (6.17 mmol) FeCl₃ and 0.974 g (6.26 mmol) KMnO₄ (total: 12.43 mmol transition metal, molar ratio FeCl₃ to KMnO₄ 0.99:1).

The preparation of the MEAs was performed in the same manner as described in the section “Influence of the doping agent”. The loading of the cathode was 3.2 mg cm⁻² for both of the catalysts.

The measurement of the polarization curves was performed in the same manner as already described in the section “Influence of the doping agent”, but using the gases H₂—O₂.

Effect of an Increased Pyrolysis Temperature

The polypyrrole-methyl orange-based catalyst system with iron and manganese was also called on here as a model compound which is analogous to the prior art. Precursor mixtures prepared in the same manner were pyrolyzed at 800° C., 900° C. and 1000° C. The synthesis for this purpose is described in model Example 11.

FIG. 12 shows for these the relative change in the current in potentiostatic measurements at 0.6 V (H₂/O₂). It is clearly apparent that the relative current density is even higher, the higher the pyrolysis temperature was, hence it becomes clear that the stability of the catalyst can be further increased if the temperature of the pyrolysis step is increased from 800° C. to 1000° C.

The preparation of the MEAs was performed in the same manner as described in the section “Influence of the doping agent”. The loading of the cathode was 3.3 mg cm⁻² for the catalyst which was pyrolyzed at 800° C. and in each case 3.4 mg cm⁻² for both of the catalysts which were produced at 900° C. or 1000° C.

The potentiostatic measurements were performed in an analogous manner to those already described in the section “Effect of manganese salts as an additional metal source”.

Influence of an Additional Solvent on the Acid Etching Step

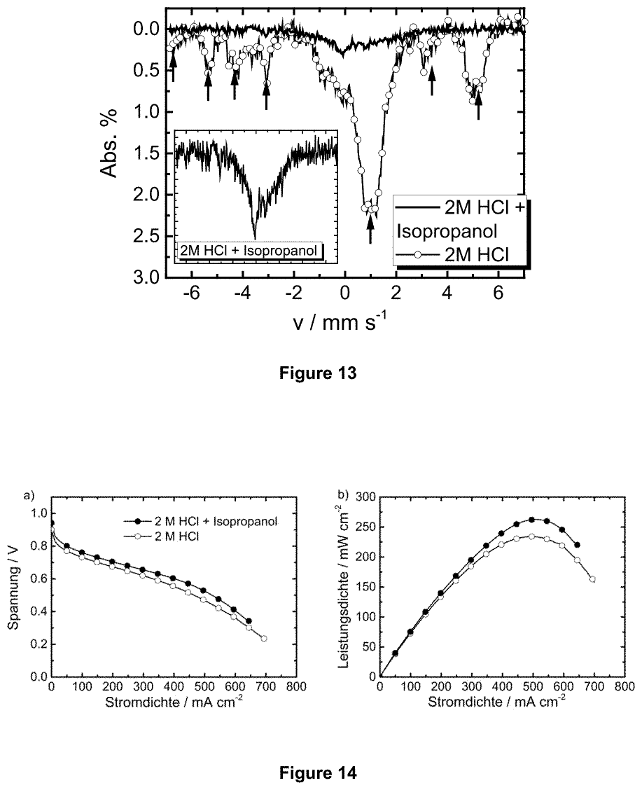

In order to study the influence of a solvent added in addition to the mineral acid during the acid etching step, catalysts, as described in model Example 12, were produced. FIG. 13 shows a ⁵⁷Fe-Mössbauer spectrum of a catalyst etched with 2 M HCl in comparison with one etched with 2 M HCl+isopropanol.

It is clearly apparent from the spectrum that the acid etching step becomes significantly more effective with the addition of the solvent than in the prior art. Significantly more undesirable inorganic iron secondary phases can be removed. The iron secondary phases are marked by arrows. It becomes clear that the quantity of catalytically inactive inorganic iron secondary phases could be significantly reduced by the addition of the solvent. For the purpose of illustration, an enlarged spectrum in which no inorganic secondary phases can be seen is represented in the insert for the catalyst etched with the addition of the isopropanol.

FIG. 14 shows the polarization curves of the catalysts produced as described in model Example 12 under H₂ air. It is apparent that the activity of the catalyst is not lower after the etching step with 2 M HCl and isopropanol, but rather is slightly increased. This is a surprising effect since, proceeding from the prior art, it should on the contrary be expected that a method for greater removal of the iron phases in the catalyst equally applies to all iron phases, therefore inorganic iron phases as well as molecular active centers. This is, however, not the case for the acid etching step with additional use of a solvent such as, for example, isopropanol. Instead, this etching step brings about an improvement in the removal of undesirable inorganic iron phases alongside consistent or even slightly increased activity.

The measurement of the ⁵⁷Fe-Mössbauer spectra was performed with a transmission Mössbauer apparatus using a ⁵⁷Co/Rh source and a proportional counter tube as a detector. The catalyst powder was filled in each case into flat sample holders and sealed off with conventional adhesive tape. The samples were measured in a speed range ±7 mm s⁻¹, wherein the speed scale was calibrated with the aid of an alpha-iron film. The spectra are plotted as relative absorption (100%=transmission+absorption).

The preparation of the MEAs was performed in the same manner as described in the section “Influence of the doping agent”. The loading of the cathode was 3.4 mg cm⁻² for the catalyst which was etched with 2 M HCl and 3.3 mg cm⁻² for the catalyst which was etched with 2 M HCl and isopropanol.

The measurement of the polarization curves was performed in the same manner as already described in the section “Influence of the doping agent”.

Influence of the Fluorination with Heat Treatment

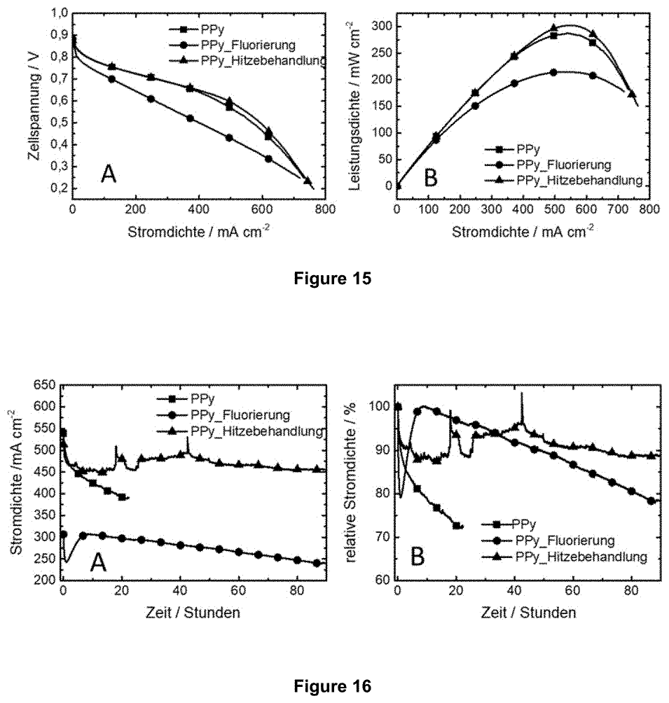

The effect of the fluorination of the catalyst with subsequent heat treatment was examined in FIGS. 15 and 16. As is clearly apparent from the data plotted, the fluorination of the catalyst brings about a significant drop in activity alongside improved stability. As a result of the heat treatment, the activity level can even once again be increased slightly above the initial value. The stability is simultaneously significantly improved.

What is claimed is:

1. A method for producing a carrier-free oxygen reduction catalyst for use in low-temperature fuel cells containing in the indicated sequence the steps;
a) producing a solution of a nitrogenous aromatic monomer, which leads to conductive polymers, and an aromatic sulfonic acid,
b) producing a solution of an oxidizing agent,
c) mixing the solutions from step a) and b) and allowing the mixture to stand to produce a doped conductive polymer, wherein the solutions from step a) and b) can optionally be mixed with one or more transition metal salts in order to directly obtain a precursor mixture,
d) in so far as the precursor mixture was not already produced in step c), producing the precursor mixture by 1.) mixing the doped conductive polymer with one or more transition metal salts or 2.) impregnating the doped conductive polymer with a dispersion of one or more transition metal salts,
e) pyrolysis of the precursor mixture in an inert gas atmosphere for producing the catalyst,
f) performing an acid etching step with a mixture of a mineral acid and a solvent for producing an etched catalyst,
g) pyrolysis of the etched catalyst in an inert gas atmosphere or a reactive gas atmosphere,
h) optionally repeating steps f) and g).

2. The method as claimed in claim 1, wherein the nitrogenous aromatic monomer which leads to conductive polymers is selected from pyrrole, aniline, carbazole and indole and the aromatic sulfonic acid is selected from sulfanilic acid, benzenesulfonic acid, toluenesulfonic acid, dodecylbenzenesulfonic acid and naphthalenesulfonic acid.

3. The method as claimed in claim 1, that wherein in step a) the molar ratio of nitrogenous aromatic monomer to aromatic sulfonic acid is from 30:1 to 1:1.

4. The method as claimed in claim 1, wherein the molar ratio of oxidizing agent in step b) to nitrogenous aromatic monomer in step a) is from 1:5 to 5:1.

5. The method as claimed in any claim 1, wherein the oxidizing agent in step b) is selected from a trivalent iron salt, in particular FeCl₃, H₂O₂ and ammonium peroxodisulfate.

6. The method as claimed in claim 1, wherein the allowing to stand in step c) is performed for 1-60 hours at a temperature of −25° C. to 25° C.

7. The method as claimed in claim 1, wherein the transition metal salts in step c) and d) are selected from salts of Fe, Mn, Co, Ni, Cu, Cr, V, W, Mo, Zn and Ru, in particular from FeCl₃, FeCl₂, Fe(NO₃)₃, KMnO₄, CoCl₂ and Co(NO₃)₂, preferably as combinations CoCl₂/Co(NO₃)₂, FeCl₃/KMnO₄, FeCl₃/Mn(Ac)₂ and FeCl₃/Fe(NO₃)₃.

8. The method as claimed in claim 1, wherein in step c) or d) the weight ratio of doped conductive polymer to transition metal salts is from 1:0.1 to 1:10.

9. The method as claimed in claim 1, wherein the mixing in step d) 1.) is a mechanical mixing and is performed in a ball mill.

10. The method as claimed in claim 1, wherein during pyrolysis in step e) and/or g) heating up is performed with a heating rate of 100° C./h to 1000° C./h to a temperature of 600° C. to 1200° C., this temperature is maintained for 0.1 h to 10 h and subsequently cooling to 10° C. to 100° C. is performed.

11. The method as claimed in claim 10, wherein the obtained catalyst is fluorinated and subsequently pyrolyzed again after the pyrolysis in step g) by reaction with a fluorinating agent.

12. The method as claimed in claim 11, wherein the fluorinating agent comprises a fluoride compound with a primary amino group and a nitrite compound.

13. The method as claimed in claim 12, wherein the fluoride compound with a primary amino group is a perfluorinated aromatic compound, in particular pentafluoro-aniline, and/or the nitrite compound is an inorganic nitrite salt, in particular an alkali metal nitrite.

14. The method as claimed in claim 1, wherein the acid etching step in step f) is performed for 1 h to 10 h in an ultrasound bath in an inert gas atmosphere at a temperature of 20° C. to 100° C.

15. The method as claimed in claim 1, wherein the acid etching step in step f) is performed with a 0.1 M to 10 M mineral acid and an organic solvent selected from isopropanol, ethanol, methanol, polyols, such as, for example, ethylene glycol, diethylene glycol, triethylene glycol, glycerol and propylene glycol, dimethylformamide, tetrahydrofuran and pyridine, wherein the volume ratio of mineral acid to solvent is 1:10 to 10:1.

16. The method as claimed in claim 1, wherein, after the acid etching step in step f), the mixture is allowed to rest for 10 h to 24 h, before it is filtered, washed and dried.

17. The method as claimed in claim 1, wherein, during the pyrolysis in step g), the reactive gas is selected from N₂/H₂, H₂, CO₂, NH₃.

18. A carrier-free oxygen reduction catalyst produced as claimed in claim 1.

19. The carrier-free oxygen reduction catalyst as claimed in claim 18, wherein the precursor of the doped conductive polymer does not have a nanotube structure.
